(19) United States
(12) Patent Application Publication
(10) Pub. No.: US 2024/0255037 A1
(43) Pub. Date: Aug. 1, 2024

(54) METHOD FOR SUCTIONING BRAKING PARTICLES

(71) Applicants: TALLANO TECHNOLOGIES, Paris (FR); AKWEL, CHAMPFROMIER (FR)

(72) Inventors: Christophe ROCCA-SERRA, PARIS (FR); Loïc ADAMCZAK, MONTALIEU VERCIEU (FR)

(21) Appl. No.: 18/564,044

(22) PCT Filed: May 31, 2022
(86) PCT No.: PCT/FR2022/051031

§ 371 Date: Nov. 24, 2023

(30) Foreign Application Priority Data
Jun. 1, 2021 (FR) FR2105771

(51) Int. Cl. F16D 65/00

(52) U.S. Cl. CPC F16D 65/0031

(57) ABSTRACT

Method for controlling a braking particle suction system, the suction system including a negative pressure source, a suction mouth arranged close to a friction interface or inside a friction part and connected by a pneumatic line to the negative pressure source, and a control unit configured to control the negative pressure source in order to: a— control a braking suction sequence according to the current braking activation information, to ensure that suction is applied as soon as braking is activated; b— establish a cleaning suction condition, outside of braking sequences; c— as soon as the cleaning suction condition satisfies a predetermined criterion, control the negative pressure source for a cleaning sequence for the pneumatic line, for a predetermined duration.

### TECHNICAL FIELD

The invention relates to braking particle suction systems in friction braking systems. Such friction braking systems can be fitted to road or rail vehicles. Such friction braking systems can also be fitted to stationary rotor-based machines such as wind turbines or industrial machines.

### CONTEXT AND PRIOR ART

In such systems, as described for example in document DE4240873, a suction turbine and a particle collection filter are provided. Particles from abrasion are thus gradually accumulated in the collection filter. This results in a progressive clogging of the filter and the pneumatic lines which lead to the filter. When friction pads are used, suction grooves can be provided in the friction material as taught by the applicant, for example in document FR3057040.

Document FR3088395 provided a control solution adapted to optimize turbine control during braking and to indicate a clogged state of the filter.

The inventors, however, noticed that the pneumatic lines tended to become clogged over time, due to a small deposit of braking particles which gradually accumulate therein.

The object of the present invention is to propose an improved solution for maintaining pneumatic lines in a satisfactory state.

### SUMMARY OF THE INVENTION

For this purpose, a method is proposed for controlling a braking particle suction system of a friction braking system, the suction system comprising:
at least one negative pressure source, at least one suction mouth arranged close to a friction interface or inside a friction part and connected by at least one pneumatic line to the negative pressure source, a control unit configured to control the negative pressure source, and a means of supplying current braking activation information, the method providing that the control unit is configured to:
a— control the negative pressure source (for example the rotation of the turbine), for a braking suction sequence, according to the current braking activation information, in order to ensure suction is applied as soon as (and as long as) braking is activated,
b— establish at least one cleaning suction condition, outside of the braking sequences,
c— as soon as the at least one cleaning suction condition satisfies a predetermined criterion, control the negative pressure source (for example the rotation of the turbine) for a cleaning sequence for the at least one pneumatic line, for a predetermined duration (TN).

By means of these arrangements, a sequence with high pneumatic flow can be provided, which makes it possible to clean the pneumatic line(s). While driving, any whistling noise due to this operation is covered by the rolling noise, given that this operation is carried out when the vehicle is traveling above a threshold speed. A cleaning sequence could also be called upon for maintenance reasons or in diagnostic conditions.

One will note that the braking suction sequences are carried out at a low flow rate, while conversely the cleaning sequences are carried out at a high flow rate, by having increased the airflow-limiting cross-sectional area at the suction mouth.

The term “friction interface” designates a [pad against disc] interface surface or a [pad against rim] interface surface, and all friction braking configurations are covered. Furthermore, “close to” means that the suctioning occurs in proximity to the interface surfaces mentioned above.

One will also note that if friction pads are used, the suction grooves made in the friction material form the suction mouth, which is then arranged inside the friction part that constitutes the friction pad.

In various embodiments of the invention relating to the method, it is possible to additionally make use of one or more of the following arrangements, individually or in combination.

According to one option, in step b—, the determination of the cleaning suction condition is a logical/algorithmic calculation which takes into account at least one of the following variables:
the current speed of the vehicle, in particular above a first speed threshold (V1),
the time elapsed since the last cleaning sequence,
the distance traveled since the last cleaning sequence,
the number of dynamic braking actions carried out since the last cleaning sequence,
the prevalence of a maintenance mode (garage mode or diagnostic mode).

Such a multi-parameter, multi-criteria condition is used in order to decide to trigger the cleaning sequence in the most optimized manner possible; in other words, the number of cleaning sequences relative to the desired efficiency in maintaining the lines in good condition is minimized.

Dynamic braking is understood to mean braking carried out while the vehicle is not at zero speed.

According to one option, it may be provided that in step c—, the negative pressure source (e.g. the rotation of the turbine) is activated to maximum power. This maximizes the effect of high-flow suctioning in removing particles that may have been deposited inside the lines.

According to one option, it may be provided that the predetermined duration (TN) is selected within a range of between 3 seconds and 15 seconds. This duration is sufficient and necessary to ensuring proper cleaning of the lines.

According to one option, the cleaning sequence is triggered, outside of maintenance mode, only if the current speed of the vehicle is greater than a first speed threshold. The cleaning sequence is thus unlikely to be heard by a vehicle occupant or a passerby, because its sound level is covered by the rolling noise.

According to one option, the cleaning sequence (52) is triggered in response to a request made by a diagnostic device during maintenance mode. Thus, when exchanging brake pads, with the line disconnected and without pads, the diagnostic tool can be used to generate a suction sequence with no airflow restriction at the pad area.

According to one option, the negative pressure source is formed by a turbine driven by an electric motor (11), the control unit (6) being configured to control the electric motor. This is a flexible solution to use, as the speed of the turbine can be adjusted according to suction requirements.

According to one option, the control unit can be configured to control, during the cleaning sequence, a vent solenoid valve arranged on the pneumatic circuit close to the suction mouth. This makes it possible to further increase air flow inside the pneumatic line during the cleaning sequence. When said vent solenoid valve is activated, there is no longer any airflow-limiting section at the friction interface side.

The invention also relates to a braking particle suction system of a friction braking system, the suction system comprising at least one negative pressure source (1), at least one suction mouth (83) arranged close to a friction interface or inside a friction part and connected by at least one pneumatic line to the negative pressure source, a control unit (6) configured to control the negative pressure source, and a means of supplying current braking activation information, the suction system being configured to implement the method as described above.

According to one option, the system may further comprise at least one filter (2) for collecting the suctioned particles.

According to one option, the system comprises a centralized filter and a centralized turbine, which are connected to four or more suction mouths. In this configuration the pneumatic lines are of some length, hence the advantage of being able to clean them from time to time.

According to one option, a vent solenoid valve (59) may be provided on the pneumatic circuit and close to the suction mouth. Such a solenoid valve allows substantially increasing the airflow inside the pneumatic line during the cleaning sequence, said solenoid valve allowing the pneumatic pipe to communicate with the atmosphere (free air) on the suction mouth side.

### DESCRIPTION OF THE FIGURES

Other aspects, aims, and advantages of the invention will become apparent upon reading the following description of an embodiment of the invention, given as a non-limiting example. The invention will also be better understood with reference to the attached drawings, in which:

FIG. 1 shows a profile view of an example of a friction braking member,

FIG. 2 shows a schematic diagram of a braking particle suction system that is local to a wheel or axle,

FIG. 3 shows a schematic diagram of a braking particle suction system that is centralized for several wheels or axles,

FIG. 4 shows a functional diagram of a braking particle suction system,

FIG. 5 provides a physical illustration of the components of the braking particle suction system,

FIG. 6 shows a timing diagram illustrating at least one functionality of the system,

FIG. 7 shows a timing diagram over a longer time scale,

FIG. 8 shows a functional diagram illustrating a pneumatic line,

FIG. 9 shows another functional diagram illustrating a pneumatic line, with a vent solenoid valve,

FIG. 10 shows a variant of the schematic diagram of a friction braking particle suction system.

### DETAILED DESCRIPTION

In the various figures, the same references designate identical or similar elements. For clarity in the presentation, certain elements are not necessarily represented to scale.

### General Layout

FIG. 1 schematically represents a friction braking member. In the illustrated case, a brake disc 9 is shown that is intended to be made integral in rotation with a wheel (or an axle for railway equipment). Disc 9 rotates around axis A. According to the prior art, a caliper 7 is placed astride the disc and mounted on a caliper support. In addition, the caliper includes a piston configured to act on friction pads in order grasp the disc in a sandwich. The friction pads are mounted on backing plates. All of this is known per se and is not described in detail here. The pads are labeled 19 and represented with dotted lines in certain views.

Although a diagram of a disc brake has been shown, the invention is also suitable for drum brakes, or even brake pad systems applied directly to the wheel rim.

At the location of the friction pads, a device 8 is provided for capturing particles which are released from them. More particularly, a suction mouth 83 can be provided for each of the friction pads. An example can be found, for example, in document FR3057040 filed by the present applicant, where the particles are captured in grooves made in the friction material. The suction mouth can be formed by the groove(s) itself connected to a through-hole in the backplate of the friction lining and in communication with a downstream passage (leading towards the filter).

Suction mouth 83 is connected to a negative pressure source by a pneumatic circuit. The pneumatic circuit can comprise a first line 3 and a second line 30, as illustrated schematically in FIG. 5. Of course, there can be a single line 3 if the filter and turbine are associated.

Generally speaking, the suction mouth can be located in the path of the particles as they exit the interface between the pad and the rotating member (disc, drum, rim, etc.). It is the negative pressure or the flow created at this location which contributes to a good capture.

In other configurations, a cover can be provided, in which case the suction mouth is formed by the outlet from the space covered by said cover.

It should therefore be understood that the invention can be applied regardless of the configuration of suction mouth 83.

Typically, for a disc brake configuration, there will be a suction mouth 83 on each side of the disc as shown in FIG. 1.

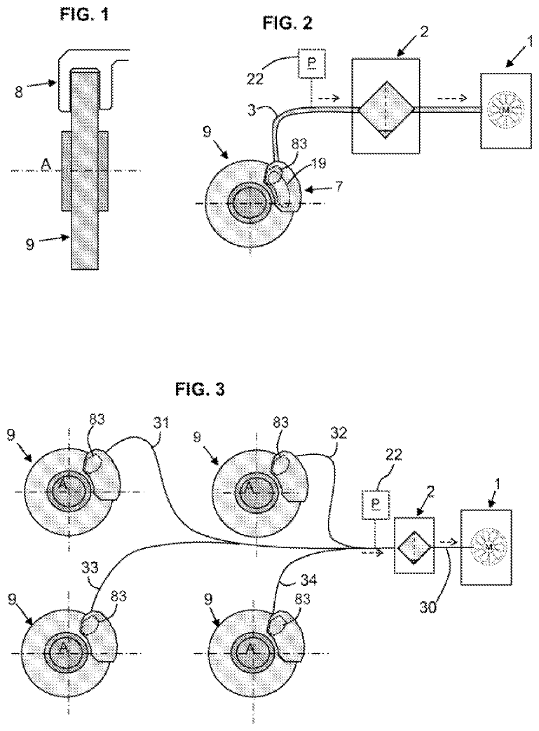

The suction mouth (or suction mouths depending on the case) is connected to a filter 2 by a fluid line which here is called first line 3, as exemplified in FIG. 2. First line 3 can be in the form of piping but this does not exclude a passage in the form of a tunnel through a part (for example the body of the caliper). The first line can have a length that is more or less extensive, ranging from a few tens of centimeters, for example 50 cm, up to several meters in a centralized filtering configuration as illustrated in FIG. 3.

Generally speaking, the fluid connection between the suction mouth and filter 2 can comprise one or more branches, T-shaped or Y-shaped connectors, etc. The term pneumatic circuit can also be used to refer to the fluid lines/air hose.

The fluid connection between the suction mouth and filter 2 can comprise rigid portions and flexible line portions.

There can be different configurations between the suction mouths, the filter, and the negative pressure source: there can be a filter for each suction mouth (configuration that maximizes decentralization), or even for each pair of suction mouths (FIG. 2), but it is also possible to have a single filter for a plurality of pairs of suction mouths (FIG. 3) (referred to as the centralized configuration), or even a single filter for the entire vehicle. This choice may be dictated by the type of vehicle, the lifespan required for the filter before clogging, the various constraints on installation in the vehicle, etc.

In FIGS. 2, 6, and 7, a configuration under negative pressure is shown, with the filter interposed between first line 3 and negative pressure source 1 which sucks the particles through the filter which is then under negative pressure relative to the external ambient pressure. However, in a configuration shown in FIG. 10, the negative pressure source (here turbine 1) can be interposed between first line 3 and the filter, in which case the turbine sucks up the particles then the turbine blows them into the filter via a downstream line denoted 3′ having a second sensor 23 (optional). In this case, filter 2 is at positive pressure instead of negative pressure.

In a typical embodiment, filter 2 can comprise a filtering medium, such as paper or some other type, allowing air to pass but trapping the small particles contained in the flow from the suction mouths.

The term ‘filter’ is to be understood broadly here, this term encompassing centrifugal filter solutions (‘cyclone’ type), filter solutions with an electromagnetic trapping technique, and filter solutions with an electrostatic trapping technique. The term ‘filter’ also includes a solution where the particles are directed towards an already existing filter such as the passenger compartment air filter or towards the filter of the catalytic converter.

Particle filter 2 is configured to filter the air coming from the suction mouths which contains solid particles having nanometric or micrometric or millimetric dimensions, meaning it allows air to pass through the filtering medium while the particles do not pass through the filtering medium and are trapped in it. The quantity of particles trapped in the filtering medium increases over time; therefore filter 2 functions by accumulation, and the passage of air through the filtering medium gradually becomes more difficult.

Over time and from the succession of braking actions, particles are deposited in the pneumatic line(s). The cumulative amount increases with time and with braking actions. This deposit varies according to the nature and quality of the friction material, according to the climatic conditions encountered, etc.

In the example illustrated, negative pressure source 1 is formed by a suction turbine 10 driven by an electric motor 11.

In the example illustrated, the turbine with its electric motor forms a separate entity from the filter. Under these conditions, a second pneumatic fluid line 30 is provided to connect the turbine to the filter.

It should be noted that a configuration with the turbine and filter in a single entity is also possible.

According to one optional arrangement, there may also be a pressure sensor 22 provided, configured to measure the pressure prevailing in first line 3. In the schematic diagram of FIG. 2, pressure sensor 22 is arranged on the path of first line 3, between at least one suction mouth and filter 2.

However, in an alternative and equally preferred configuration, pressure sensor 22 is arranged adjacent to or integrated with filter 2, as illustrated in FIG. 5.

### Control Unit

The suction system further comprises a control unit 6 configured to control the turbine.

Control unit 6 is an electronic unit capable of generating a control signal to control the speed of the motor which drives the turbine, according to any value between zero speed and the maximum possible speed.

According to one example, electric motor 11 is powered by DC voltage; it may be provided that the control logic uses a PWM signal (pulse width modulation). The DC voltage used may depend on the field of application of the particle suction system, for example 12 Volts on conventional motor vehicles, 24 Volts on heavy goods vehicles or industrial vehicles such as trucks or buses, or 72 Volts on railway equipment (tramway, train).

It should be noted here that instead of a suction turbine, the negative pressure source can be preexisting in the vehicle, in particular, in the case of the automotive sector, a source of negative pressure induced by the operation of the vehicle's engine, for example by diverting from the air intake, or in another example by the use of a Venturi effect on an outgoing stream of gas, for example exhaust gases. For the case of the railway sector, the negative pressure source can be derived from the pneumatic braking devices or other auxiliary devices of the railway vehicle in question.

According to one configuration, the targeted value for the negative pressure is chosen within a range of 20 to 100 millibar below the ambient pressure; in other words, in the absolute pressure scale, the absolute pressure setpoint in the first line can be from 90% to 98% of the atmospheric pressure prevailing in the vicinity of the suction system. Sensor 22 can be used to control the rotation speed setpoint for the turbine and thus have it rotate only to the extent necessary.

Advantageously, a means 60 is provided for supplying current braking activation information.

In certain road vehicle type configurations, there is simply an all-or-nothing binary switch interacting with brake pedal 68. This switch can deliver information 67 directly to control unit 6 of the suction system or else via a control unit 63 controlling the braking function, for example the one which manages the ABS function.

According to another configuration, richer information can be provided, analog or digital, which precisely reflects the current position of the brake pedal and thus allows control unit 6 on the one hand to know the braking intensity and on the other hand to be able to act very early when the action of the user or driver commences on the brake pedal. In this case, an analog or digital potentiometer 69 is provided, which delivers a wealth of information 66 to control unit 6 of the suction system.

Note that if the road vehicle is equipped with driving assistance including autonomous driving or an emergency braking function, braking can be activated without the pedal actually being pressed; it is then a computer which puts together the information and sends it to control unit 6 of the suction system.

Control unit 6 therefore has current braking activation information, either binary or more elaborate, at its disposal.

In another context, such as railways, the current braking activation information can come from the braking actuator which controls the friction braking mentioned above. The braking actuator may be a throttle. Here too, braking may be triggered without action on the throttle, in which case it is a computer which puts together the information and sends it to control unit 6 of the suction system.

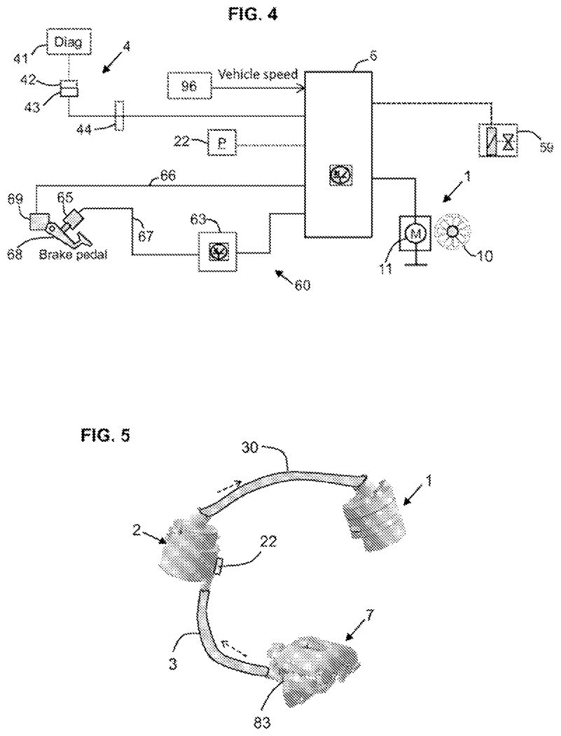

Furthermore, control unit 6 receives information concerning the current vehicle speed. This current vehicle speed information can be provided by braking computer 63 or by any other computer, denoted 96 in FIG. 4.

The “vehicle speed” information can be received by a wired connection or by a data bus type connection. A CAN or J1939 bus can be used for a road vehicle.

The “vehicle speed” information is received on a regular basis, e.g. refreshed in near real-time. For example, a refresh at least 10 times per second can be expected.

In FIG. 4, a diagnostic arrangement 4 is illustrated, which allows a diagnostic tool to communicate with control unit 6. Diagnostic arrangement 4 comprises a diagnostic tool 41, a plug 43 permanently on the vehicle, and a mating connector 42 linked to diagnostic tool 41 which allows the latter to be temporarily connected to the vehicle's computers. The messages in the diagnostic dialog may, if necessary, pass through a communication gateway 44.

Diagnostic tool 41 can be connected without wires, in “wireless” mode.

Control unit 6 is electrically powered by DC voltage supplied by the vehicle. However, powering by battery is not excluded.

### Operation

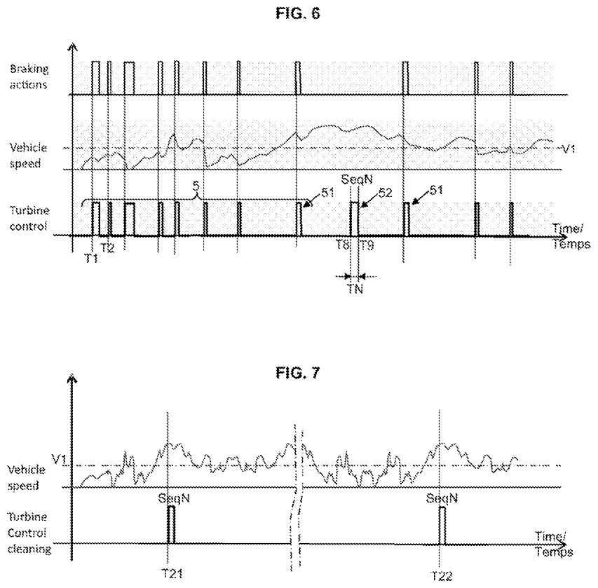

FIG. 6 illustrates a timing diagram for a first time scale (typically several tens of minutes or a few hours), while FIG. 7 illustrates a timing diagram for a second, longer time scale of several hours or several days.

First of all, one will note that generally speaking, when driving, as soon as braking is activated (timing diagram at the top of FIG. 6), control unit 6 controls the turbine for a braking suction sequence 51.

In other words, braking suction sequence 51 is implemented according to the current braking activation information, in order to ensure suction is applied as soon as braking is activated and as long as braking is activated, for as long as the vehicle is moving.

As an exception, if the vehicle speed is zero, control unit 6 may refrain from controlling the turbine.

When driving, the set of eight braking suction sequences 51 overall is denoted 5 in FIG. 6, and some of the particles which travel pneumatic line 3 may be deposited therein during the suction phases. Note that the durations of the braking suction sequences, triggered at times T1, T2, and following, are highly variable: they depend in particular on the activation duration of the brake.

Advantageously according to this proposal, it is planned to perform, independently of any braking activation, a cleaning suction sequence SeqN otherwise referred to as cleaning sequence 52, intended to clean pneumatic line 3,30. The turbine is controlled by control unit 6 to the maximum possible power. The cleaning command is applied for a predetermined duration TN. TN is chosen within a range of between 3 seconds and 15 seconds. For example one can choose TN=5 seconds, or TN=8 seconds, or even TN=10 seconds.

The conditions for triggering a cleaning sequence will be discussed below.

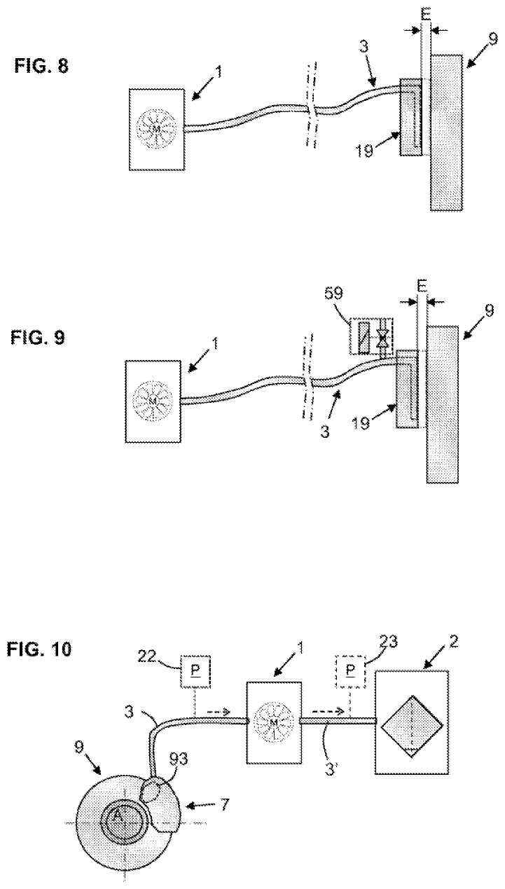

Note that the cleaning sequence is carried out when the pad is not pressed firmly against the disc. As illustrated in FIG. 8, when not braking, pad 19 is not pressed firmly against disc 9. In practice, when not braking, there is a small gap of width E (its dimension intentionally exaggerated in FIGS. 8 and 9). For the case of a railway brake, this free space can be slightly more significant.

In the case of suction mouths made in the pads, the presence of this gap forms a passage for air. The restricting cross-section from an airflow point of view is thus larger than when the pad is pressed firmly against the disc.

Indeed, when the pad is pressed firmly against the disc, the airflow-limiting cross-sectional area is determined by the groove(s) made in the pad which are of small dimensions even if there may be an air vent. The braking suction sequences are carried out essentially when the pad is applied firmly against the disc, so the braking vacuum sequences are carried out at low airflow due to a small airflow-limiting cross-sectional area.

Conversely, due to the presence of the gap mentioned above, when the pad is not applied firmly against the disc, the cleaning sequences are carried out at high air flow. This encourages the removal of particles which may have been deposited on the internal walls of the pneumatic line. A cleaning sequence makes it possible to keep the interior walls of the pneumatic line unsullied. Thus, even after a long service life of several years and/or several hundred thousand kilometers traveled, the pneumatic line(s) are not significantly obstructed.

Determining the cleaning suction condition is a logical/algorithmic calculation which takes into account one or more of the variables set forth below.

The current speed of the vehicle is a main variable. While driving, a cleaning sequence is not triggered if the vehicle speed VV is lower than a first speed threshold V1. V1=70 Km/h may be chosen. Alternatively, V1=50 Km/h may be chosen. In addition, the distance traveled since the last cleaning sequence is taken into account. For example, a cleaning sequence is triggered after the vehicle has traveled DD1=50 km since the last cleaning sequence. In other words, after a cleaning sequence, control unit 6 refrains from ordering a new cleaning sequence during the next DD1 kilometers, DD1 being a predetermined threshold. Distance traveled DD does not need to be known precisely. The distance traveled can be obtained by integrating the vehicle speed. Alternatively, it can be received from another computer, for example the dashboard.

The number of dynamic braking actions carried out since the last cleaning sequence is taken into account. For example, a cleaning sequence is triggered after N1 suction sequences are carried out on the vehicle. A value between 50 and 200 can be chosen for N1, for example N1=100.

Instead of a simple braking number, we can calculate a cumulative braking score SCF, where a weight is applied to each braking. The more violent the braking, the greater the weight. The braking power can be deduced from the speed gradient (speed decrease as a function of time).

For the criterion that triggers a cleaning sequence, one can choose the criterion defined by the logic: [SCF>SCFI or DD>DD1] and VV>VV1.

The time that has passed since the last cleaning sequence is taken into account. For example, a cleaning sequence is triggered after N2 days have passed. A value of between 10 and 30 days can be chosen for N2.

As illustrated in FIG. 7, a cleaning sequence is triggered at time T21 while the speed is higher than V1. After a certain time which can be quite long given the criteria mentioned above, another cleaning sequence T22 is triggered, again when the vehicle speed is greater than V1.

A cleaning sequence can also be used during a maintenance phase. In this case, cleaning sequence 52 is triggered in response to a request made by diagnostic equipment 41.

Here we are interested in the pad replacement operation, for example during a maintenance operation in a garage.

Generally the vehicle is not moving and the engine is not running.

Control unit 6 receives an ad-hoc diagnostic request from the diagnostic tool, and controls the turbine to its maximum speed during the cleaning sequence prescribed by the diagnostic request. The duration can be TN or shorter. Duration TN can be a parameter of the diagnostic request. Note that the mechanic can have auditory feedback from the rotation of the turbine to verify its proper operation.

As illustrated in FIG. 9, optionally, a vent solenoid valve 59 may be provided that is fluidly connected to the pneumatic circuit and is close to the suction mouth. Such a solenoid valve allows substantially increasing the airflow inside the pneumatic line during the cleaning sequence.

Control unit 6 can be configured to control, during the cleaning sequence, vent solenoid valve 59 arranged on the pneumatic circuit close to the suction mouth.

In FIG. 4, the option of vent solenoid valve 59 controlled by control unit 6 is represented.

1-12. (canceled)

13. A method for controlling a braking particle suction system of a friction braking system, the braking particle suction system comprising:
at least one negative pressure source, at least one suction mouth arranged close to a friction interface or inside a friction part and connected by at least one pneumatic line to the negative pressure source, a control unit configured to control the negative pressure source, and a means of supplying current braking activation information,
the method providing that the control unit is configured to:
a— control the negative pressure source, for a braking suction sequence, according to the current braking activation information, in order to ensure suction is applied as soon as braking is activated,
b— establish at least one cleaning suction condition, outside of any braking sequence,
c— as soon as the at least one cleaning suction condition satisfies a predetermined criterion, control the negative pressure source for a cleaning sequence for the at least one pneumatic line, for a predetermined duration,
the method providing that, in step b—, the determination of the cleaning suction condition is a logical/algorithmic calculation which takes into account at least one of the following variables:
a current speed of the vehicle,
a time elapsed since a last cleaning sequence,
a distance traveled since the last cleaning sequence,
a number of dynamic braking actions carried out since the last cleaning sequence,
a prevalence of a maintenance mode.

14. The method according to claim 13, wherein the cleaning sequence is triggered, outside of maintenance mode, only if the current speed of the vehicle is greater than a first speed threshold.

15. The method according to claim 13, wherein, in step c—, the negative pressure source is activated to maximum power.

16. The method according to claim 13, wherein the predetermined duration is selected within a range of between 3 seconds and 15 seconds.

17. The method according to claim 14, wherein the first speed threshold is greater than 50 km/h.

18. The method according to claim 13, wherein the cleaning sequence is triggered in response to a request made by a diagnostic device during maintenance mode.

19. The method according to claim 13, wherein the negative pressure source is formed by a turbine driven by an electric motor, the control unit being configured to control the electric motor.

20. The method according to claim 13, wherein the control unit is configured to control, during the cleaning sequence, a vent solenoid valve arranged on the pneumatic circuit close to the suction mouth.

21. A braking particle suction system of a friction braking system, the suction system comprising at least one negative pressure source, at least one suction mouth arranged close to a friction interface or inside a friction part and connected by at least one pneumatic line to the negative pressure source, a control unit configured to control the negative pressure source, and a means of supplying current braking activation information, the suction system being configured to implement the method according to claim 13.

22. The system according to claim 21, further comprising at least one filter for collecting the suctioned particles.

23. The system according to claim 21, wherein the system comprises a centralized filter and a centralized turbine, which are connected to four or more suction mouths.

24. The system according to claim 21, wherein a vent solenoid valve is provided on the pneumatic circuit and close to the suction mouth.
